(19) United States
(12) Patent Application Publication
(10) Pub. No.: US 2005/0281056 A1
(43) Pub. Date: Dec. 22, 2005

(54) Ornament lighting apparatus

(76) Inventor: Jason A. Loomis, Boston, MA (US)

Correspondence Address: JOHNSON & STAINBROOK LLP, Suite 203, 3558 Round Barn Blvd., Santa Rosa, CA, 95403, US

(21) Appl. No.: 11/136,773

(22) Filed: May 25, 2005

Related U.S. Application Data
(60) Provisional application No. 60/574,683, filed on May 25, 2004.

(51) Int. Cl. F21S 13/14

(52) U.S. Cl. 362/653

(57) ABSTRACT

A plug and ornament light assembly for releasable connection into a light socket on an existing light string, such that an ornament can be individually illuminated by the ornament light. The apparatus includes an ornament plug, a plug cover for securing the ornament plug into the light string light socket, and at least one ornament light such as an LED connected to the ornament plug by a segment of wire, so that the ornament light is powered by the current from the existing light string, and the ornament light is illuminated concurrently with the lights on the existing light string. Circuitry limits the voltage/current delivered to the LED ornament light, thereby eliminating the need for heavier gauge wire and fireproofing ordinarily required with higher voltage lights.

### CROSS REFERENCE TO RELATED APPLICATIONS

The present application claims the benefit of the filing date of U.S. Provisional Patent Application, Ser. No. 60/574,683, filed 25 May 2004.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to decoration, ornaments, and illuminated light strings, and more particularly to an improved ornament lighting apparatus.

U.S. Pat. No. 6,612,864 to Hsu discloses a lighting string with an extending structure, which includes an electrical wire with several bulb assemblies and some lighting units connected by extending wires. The lighting unit can emit light at a distance from the electrical wire of the lighting string to provide a special lighting effect. The lighting unit can also be connected with lighting fiber for a further extension of light.

The foregoing patent reflects the current state of the art of which the present inventor is aware. Reference to, and discussion of, this patent is intended to aid in discharging Applicant's acknowledged duty of candor in disclosing information that may be relevant to the examination of claims to the present invention. However, it is respectfully submitted that the above-indicated patent does not disclose, teach, suggest, show, or otherwise render obvious, either singly or when considered in combination with other patent or non-patent references, the invention described and claimed herein.

### BRIEF SUMMARY OF THE INVENTION

The ornament lighting apparatus of the present invention provides a plug and ornament light assembly for releasable connection into a light socket on an existing light string, such as a string of Christmas tree lights, such that an ornament can be individually illuminated by the ornament light. The inventive apparatus includes an ornament plug, a plug cover for securing the ornament plug into the light string light socket, and at least one ornament light such as an LED connected to the ornament plug by a segment of wire, so that the ornament light is powered by the current from the existing light string, and the ornament light is illuminated concurrently with the lights on the existing light string.

The inventive apparatus preferably includes circuitry that limits the voltage/current delivered to the LED ornament light, thereby eliminating the need for heavier gauge wire and fireproofing ordinarily required with higher voltage lights. This allows the user to remove a standard bulb from its socket on a light string, and plug the inventive apparatus into that socket on the light string for illumination of an ornament, without adversely affecting the performance of the lights on the rest of the light string.

It is therefore an object of the present invention to provide a new and improved lighting apparatus.

It is another object of the present invention to provide a new and improved ornament that can be individually illuminated.

A further object or feature of the present invention is a new and improved illuminated ornament that can be attached to an existing light string.

An even further object of the present invention is to provide a novel circuit to limit the voltage/current delivered to an ornament light.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a plan view of an ornament lighting apparatus of this invention;

FIGS. 2A-2D are a series of views illustrating an ornament lighting apparatus of this invention being installed on a typical light string;

FIG. 3 is a plan view of an ornament lighting apparatus of this invention as installed on a light string and illuminated concurrently with the other preexisting lights on the light string; and

FIG. 4 is a schematic view of a voltage/current limiting circuit for the ornament lighting apparatus of this invention.

### DETAILED DESCRIPTION OF THE INVENTION

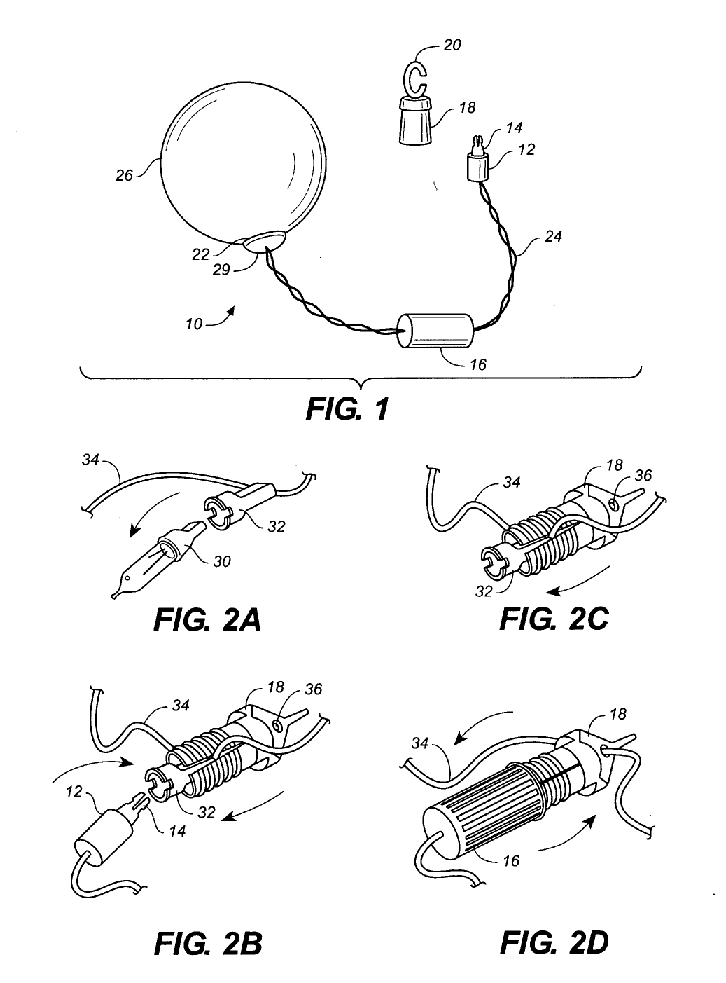

Referring to FIGS. 1 through 4, wherein like reference numerals refer to like components in the various views, there is illustrated therein a new and improved ornament lighting apparatus, generally denominated 10 herein.

FIG. 1 illustrates a first preferred embodiment of the ornament lighting apparatus 10, comprising an ornament plug 12, preferably having split or biased contacts 14 so that the leads will make connection in a variety of different diameter bulb sockets by adjusting to the diameter of the socket. A plug cover 16 nests over and secures the ornament plug 12 into the light string light socket. In the preferred embodiment, the plug cover 16 is threaded and mates to a threaded socket cover 18 placed over the other side of the light socket. Alternatively, any other mechanical arrangement could be incorporated to securely lock the ornament plug into the light socket. As designed, the inventive plug and cover provides a universal adapter capable of secure connection to most known light strings. Threaded socket cover 18 may include a hook 20 for hanging to a tree branch or other support.

At least one ornament light such as an LED or LED array 22 is connected to the ornament plug 12 by a pigtail or segment of wire 24. The LED 22 may be contained in an ornament cap or cover 24, so that the cover may be removed from an ornament 26 and placed on a different ornament for illumination, if desired.

FIGS. 2A-2D are a series of views illustrating an ornament lighting apparatus of this invention being installed on a typical light string. FIG. 2A shows a light bulb 30 being removed from a light socket 32 on an existing light string 34. FIG. 2B shows the ornament plug being inserted into the light socket 32 so that the contacts 14 contact the leads in the light socket (not visible). FIG. 2C shows the threaded socket cover 18 being placed over the light socket 32, so that the light string passes through aperture 36. FIG. 2D shows the plug cover 16 being placed on to threaded socket cover 18 to capture the ornament plug within. Pigtail 24 freely passes through hole 38.

In the preferred embodiment, the threaded socket cover 18 has a slightly larger inside diameter than the ornament plug 12 outside diameter; which will control the diameter of the socket cover regardless of the outside diameter of the light socket on the light string. The plug cover 16 preferably has a slightly larger inside diameter than the outside diameter of the threaded socket cover 18. The plug cover 16 is preferably shorter than the threaded socket cover 18, thus when screwed onto the threaded socket cover it will force the ornament plug 12 to be seated well, ensuring good connection, into the light socket 32.

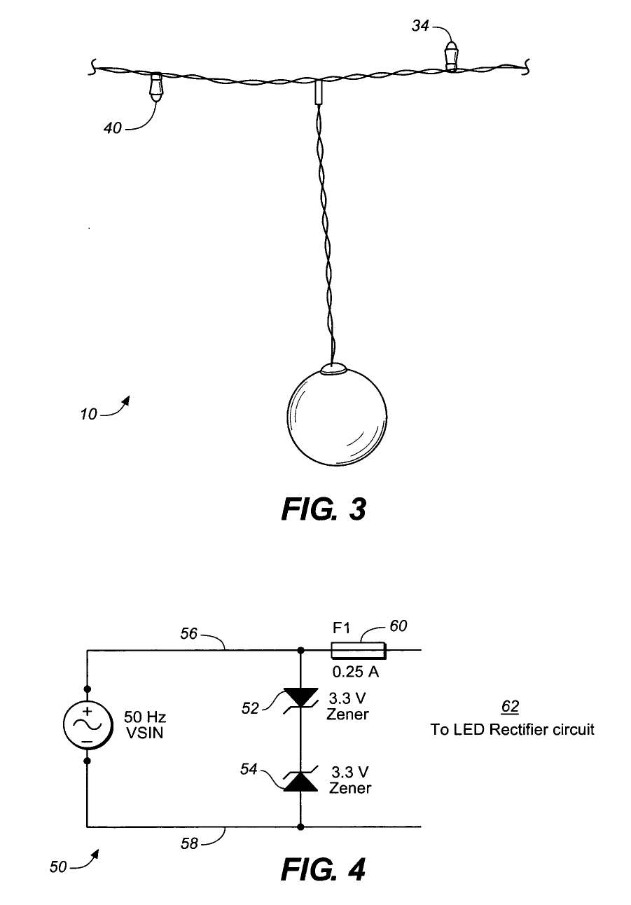

FIG. 3 is a plan view of an ornament lighting apparatus 10 of this invention as installed on a light string and illuminated concurrently with other preexisting lights 40 on the light string. Illumination of the ornament lighting apparatus is accomplished without adversely affecting the performance of the lights on the rest of the light string.

FIG. 4 is a schematic view of a voltage/current limiting circuit 50 for the ornament lighting apparatus of this invention. Circuit 50 includes a pair of Zener diodes 52, 54 connected across leads 56, 58, with fuse 60 interposed in the circuit to the LED rectifier circuit 62. This provides the necessary power conversion required to power the LEDs from a standard AC light strings. This also serves as a voltage limiter. The fuse 60 prevents the circuit from burning in the event of a power surge or other electrical anomaly. It also relegates the rest of the light array as a low-voltage device for the purpose of UL certification. This limiting circuit 50 is preferably incorporated into the ornament plug itself, close to the light socket, thereby eliminating the need for heavier gauge wire and fireproofing downstream from the circuit.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. An ornament lighting apparatus for releasable connection into a light socket on an existing light string, said apparatus comprising:
an ornament plug;
a plug cover for securing said ornament plug into the light string light socket; and
at least one ornament light connected to said ornament plug by a segment of wire, wherein said ornament light is powered by the current from the existing light string.

2. The ornament lighting apparatus of claim 1 wherein said ornament light comprises an LED.

3. The ornament lighting apparatus of claim 1 wherein said plug cover mates to a threaded socket cover.

4. The ornament lighting apparatus of claim 3 wherein said threaded socket cover includes a hook for hanging to a support.

5. The ornament lighting apparatus of claim 3 wherein said threaded socket cover includes an aperture for passage of the light string.

6. The ornament lighting apparatus of claim 1 wherein said plug cover includes an aperture for passage of said segment of wire.

7. The ornament lighting apparatus of claim 1 wherein said apparatus includes circuitry to limit the voltage/current delivered to said ornament light.

8. The ornament lighting apparatus of claim 1 wherein said ornament plug includes biased contacts.

9. The ornament lighting apparatus of claim 1 wherein said ornament light is connected to an ornament cap.
